(19) United States
(12) Patent Application Publication
(10) Pub. No.: US 2026/0025648 A1
(43) Pub. Date: Jan. 22, 2026

(54) POWER EFFICIENT MOBILITY MEASUREMENTS IN A WIRELESS COMMUNICATION DEVICE

(71) Applicant: Telefonaktiebolaget LM Ericsson (publ), Stockholm (SE)

(72) Inventors: Andres REIAL, Höllviken (SE); Gang ZOU, Lund (SE); Sina MALEKI, Malmö (SE)

(21) Appl. No.: 18/854,530

(22) PCT Filed: Jun. 22, 2022
(86) PCT No.: PCT/EP2022/066988

§ 371 Date: Oct. 5, 2024

(51) Int. Cl. H04W 8/02; H04W 24/10

(52) U.S. Cl. CPC H04W 8/02; H04W 24/10

(57) ABSTRACT

A wireless communication device is operated in a wireless communication network, wherein the wireless communication device comprises a first receiver that consumes power at a first rate, and a second receiver that consumes power at a second rate, wherein the first rate is higher than the second rate. Operation of the device includes obtaining one or more calibration factors that relate time domain properties of transmitted signals when received by the first receiver and time domain properties of the transmitted signals when received by the second receiver, and using the second receiver to collect signal information from one or more transmissions of a measurement object that is located within corresponding one or more radiofrequency transmissions performed by the wireless communication network. The signal information collected by the second receiver and the one or more calibration factors are used to produce a measurement result representative of one or both of signal power and link quality of a communication link between the wireless communication device and the wireless communication network. The measurement result is used as a basis for deciding whether or not to execute a mobility procedure.

### BACKGROUND

The present invention relates to technology for measuring, at a wireless communication device, radio link power and/or radio link quality, and more particularly to technology for performing such measurements in a power efficient way.

Mobility measurements are important in cellular communication technology because they are a measure of the quality of a wireless link between a user equipment (UE) and a node (e.g., a base station) that serves the UE, and therefore indicate whether that wireless link is satisfactory, or whether, as part of Radio Resource Management (RRM), a mobility procedure such as a handover to a different network resource (e.g., different cell, node, frequency resource, transmission/reception beam, and the like) should be performed.

Many different types of information are carried on a wireless link between a UE and its serving node, some being for control and synchronization of the connection, and others carrying the higher layer information to be communicated from one location to another. The wireless link between a UE and its serving node is characterized by a number of parameters including but not limited to a carrier frequency, bandwidth, and timing. For purposes of mobility measurements, a number of different parts of a wireless link, so-called “mobility management objects”, can be measured, and each has a specified frequency and time location in the air interface that is defined for the communication system.

For example, a number of different mobility objects can be measured in the Third Generation Partnership Project (3GPP) standards for New Radio (NR). When operating in an idle/inactive mode, the UE is to monitor the quality of a Synchronization Signal Block (SSB) broadcast by its own (camping) cell as well as the SSB(s) of other (candidate) cells, and this involves measuring signal quality of a Secondary Synchronization Signal (SSB) located within the SSB. Optionally, either in addition or as an alternative, the UE may measure the Physical Broadcast CHannel (PBCH) Demodulation Reference Signal (DMRS).

When operating in connected mode, the RRM mobility measurement objects may be the SSB or a Channel State Information Reference Signal (CSI-RS) transmitted by the UE's serving and neighbor cells.

A common approach is to configure the UF to perform periodic measurements, typically once per Discontinuous Reception (DRX) (or connected-mode DRX-“cDRX”) cycle. SSBs are conventionally transmitted at known times according to different time domain patterns, depending on which subcarrier spacing value is being used. These patterns are known in the art and need not be described here in detail. See, for example, X. Lin et al., “5G New Radio: Unveiling the Essentials of the Next Generation Wireless Access Technology,” in IEEE Communications Standards Magazine, vol. 3, no. 3, pp. 30-37, September 2019, doi: 10.1109/MCOMSTD.001.1800036.

FIG. 1 is a diagram of an SSB 101, showing the frequency and timing configurations of an SSB 100. The SSB is referred to as a “block” because, in accordance with NB standardization, the synchronization signals and PBCH are packed as a single block. The synchronization signals comprise the PSS and the SSS. The PBCH data comprises the DMRS and cell system information. Detection of SSB is important because the UE relies on it to synchronize with network and perform beam monitoring and neighbor/serving cell measurements.

As can be seen in FIG. 1, each SSS has a length of one symbol which, for the case of 30 kHz subcarrier spacing (SCS), lasts 36 μs. The configuration of the SSS is fixed on a per-cell basis and has the following characteristics:
Bandwidth utilization for the SSS is 12 Physical Resource Blocks (PRBs) (144 subcarriers), with the center 127 subcarriers constituting the SSS itself and the remaining subcarriers being situated adjacent each side of the SSS for use as guard bands.
A defined carrier frequency
Predefined contents (fixed per cell and selected out of approximately 1000 options)

Also as shown in FIG. 1, each SSB has a duration of 4 symbols per instance. Based on a system that 64 beams with 2 SSBs per slot, 32 slots are used, so an SSB burst transmission comprises a sweep of from 4 to 64 instances (2-4 ms), depending on which subcarrier spacing is being used.

As mentioned earlier, in addition to its use for synchronization, the SSS is one example of a mobility measurement object 101, as shown in the figure. However, as used herein, the term “mobility measurement object 101” is used more generally to refer to any aspect or portion of a radio transmission that serves as such an object for purposes of deciding whether to carry out a mobility procedure.

Continuing with reference to NR technology as an example, a UE performs periodic mobility measurements in both idle/inactive mode and in common connected mode configurations by receiving SSBs of the current camping/serving cell and optionally on neighbor cells. This requires waking up the cellular radio receiver if it is not already awake, sampling the received signal that contains the SSBs of interest, and estimating a signal quality metric from the received signal. To separate the signal components of interest (e.g., the SSS), the estimation is typically performed in the frequency domain. In the frequency domain, other supporting information, such as System Information (SI) of cells, may also be extracted.

However, the UE energy consumption cost of periodically activating the radio and performing sample collection and baseband processing is high, especially for UEs with low-volume and/or infrequent data transmissions that stay in idle/inactive mode during the majority of their operating time. This energy consumption in turn reduces the UE's battery time. The problem can be even worse when the required measurement period is shorter than the paging DRX period, or when the SSB-to-paging occasion (PO) offset is long because this results in two separate wakeups being needed.

One proposal for addressing this problem involves conserving UE power consumption by relaxing the requirements for mobility measurements such that it would be permissible to perform the measurements less frequently. However, this solution has the drawback of being applicable mostly to only the subset of UEs that are guaranteed to be in a robust location mobility-wise (e.g., with high link quality (high margin to link failure) or low-mobility (unlikely to experience link changes)). Without these restrictions, measurement relaxation could lead to loss of mobility performance and link failure.

There is thus a need for technological improvements that address the above and/or related problems and thereby allow saving UE energy in the context of mobility measurements without sacrificing mobility robustness or requiring changes to mobility procedures.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) in which a wireless communication device in a wireless communication network is operated, wherein the wireless communication device comprises a first receiver that consumes power at a first rate, and a second receiver that consumes power at a second rate, wherein the first rate is higher than the second rate. Operation of the wireless communication device comprises obtaining one or more calibration factors that relate time domain properties of transmitted signals when received by the first receiver and time domain properties of the transmitted signals when received by the second receiver. The second receiver is used to collect signal information from one or more transmissions of a measurement object that is located within corresponding one or more radiofrequency transmissions performed by the wireless communication network. The signal information collected by the second receiver and the one or more calibration factors are used to produce a measurement result representative of one or both of signal power and link quality of a communication link between the wireless communication device and the wireless communication network. The measurement result is used as a basis for deciding whether or not to execute a mobility procedure.

In an aspect of some but not necessarily all embodiments, operation of the wireless communication device comprises using the first receiver to receive the measurement object; and determining time domain properties of the measurement object that was received by the first receiver, wherein the time domain properties characterize a timing of transmissions of the measurement object and a time domain representation of a reference sequence represented by the measurement object.

In another aspect of some but not necessarily all embodiments, using the second receiver to collect the signal information from the one or more transmissions of the measurement object comprises using the time domain properties of the measurement object as a basis for configuring the second receiver to collect the signal information from the one or more transmissions of the measurement object.

In yet another aspect of some but not necessarily all embodiments, operation of the wireless communication device comprises performing the mobility procedure in a controller of the second receiver when it is decided to execute the mobility procedure.

In still another aspect of some but not necessarily all embodiments, operation of the wireless communication device comprises performing the mobility procedure in a controller of the first receiver when it is decided to execute the mobility procedure.

In another aspect of some but not necessarily all embodiments, operation of the wireless communication device comprises, when it is decided to execute the mobility procedure, performing:
deciding whether the second receiver is capable of performing the mobility procedure;
performing the mobility procedure in a controller of the second receiver when it is decided that the second receiver is capable of performing the mobility procedure; and
performing the mobility procedure in a controller of the first receiver when it is decided that the second receiver is not capable of performing the mobility procedure.

In yet another aspect of some but not necessarily all embodiments, using the signal information collected by the second receiver and the one or more calibration factors to produce the measurement result representative of one or both of signal power and link quality of the communication link between the wireless communication device and the wireless communication network comprises:
producing, from the signal information collected by the second receiver, a first measurement result representative of one or both of signal power and link quality of the communication link between the wireless communication device and the wireless communication network; and
using the calibration factors as a basis for adjusting the first measurement result to form a corrected estimate of a measurement result representative of one or both of signal power and link quality of the communication link between the wireless communication device and the wireless communication network.

In still another aspect of some but not necessarily all embodiments, using the signal information collected by the second receiver and the one or more calibration factors to produce the measurement result representative of one or both of signal power and link quality of the communication link between the wireless communication device and the wireless communication network comprises performing sliding time-domain correlation of a sample stream received by the second receiver with the time domain representation of the reference sequence represented by the measurement object.

In another aspect of some but not necessarily all embodiments, forming the estimate of the first radio measurement result representative of the link quality of the communication link between the wireless communication device and the wireless communication network comprises scaling a correlation output of the sliding time-domain correlation by one or more of the one or more calibration factors.

In yet another aspect of some but not necessarily all embodiments, operation of the wireless communication device comprises, when the wireless communication device is operating in a connected mode that comprises alternating awake and sleep states, performing a plurality of measurements of measurement objects during each sleep state by:
using the second receiver to measure a first number of measurement objects that are transmitted during a first-occurring part of the sleep state; and
using the first receiver to measure a second number of measurement objects that are transmitted during a last-occurring part of the sleep state.

In still another aspect of some but not necessarily all embodiments, operation of the wireless communication device comprises switching off the second receiver during each awake state.

In another aspect of some but not necessarily all embodiments, the mobility procedure is one of a cell mobility procedure and a beam management procedure.

In yet another aspect of some but not necessarily all embodiments, operation of the wireless communication device comprises, after obtaining the one or more calibration factors, performing:
using the first receiver and the second receiver to measure a same measurement object as one another to obtain a first measurement result and a second measurement result, respectively;
comparing the first measurement result with the second measurement result to produce a comparison result; and
using the first receiver instead of the second receiver to perform further measurements of further occurring measurement objects when the comparison result does not satisfy a predefined criterion.

In still another aspect of some but not necessarily all embodiments, operation of the wireless communication device comprises using the second receiver to monitor received signals to detect a receipt of a wakeup signal; and
causing the first receiver to wake up when the receipt of the wakeup signal is detected.

In still another aspect of some but not necessarily all embodiments, operation of the wireless communication device comprises using the second receiver to perform a cell search procedure.

In another aspect of some but not necessarily all embodiments, obtaining the calibration factors comprises:
using the first receiver to obtain a first calibration measurement by measuring the measurement object of at least one of the one or more transmissions of the measurement object;
using the second receiver to obtain a second calibration measurement by measuring the measurement object of the at least one of the one or more transmissions of the measurement object; and
deriving the calibration factors from a comparison of the first calibration measurement and the second calibration measurement.

In yet another aspect of some but not necessarily all embodiments, the signal information collected by the second receiver comprises a sample stream, and wherein using the signal information collected by the second receiver and the one or more calibration factors to produce the measurement result representative of one or both of signal power and link quality of the communication link between the wireless communication device and the wireless communication network comprises performing sliding time-domain correlation of the sample stream with one or more reference sequences corresponding to known contents of the measurement object.

In still another aspect of some but not necessarily all embodiments, using the second receiver to collect signal information from the one or more transmissions of the measurement object is performed only during predetermined measurement times, and wherein the method comprises performing the sliding time-domain correlation of the sample stream with the one or more reference sequences corresponding to known contents of the measurement object only at times associated with the predetermined measurement times.

In another aspect of some but not necessarily all embodiments, the measurement object is one or more of:
a Secondary Synchronization Signal, SSS, in a Synchronization Signal Block, SSB;
a Channel State Indicator Reference Signal, CSI-RS; and
a predefined reference signal.

### BRIEF DESCRIPTION OF THE DRAWINGS

The objects and advantages of the invention will be understood by reading the following detailed description in conjunction with the drawings in which:

FIG. 1 is a diagram of an SSB, showing the frequency and timing configurations of an SSB.

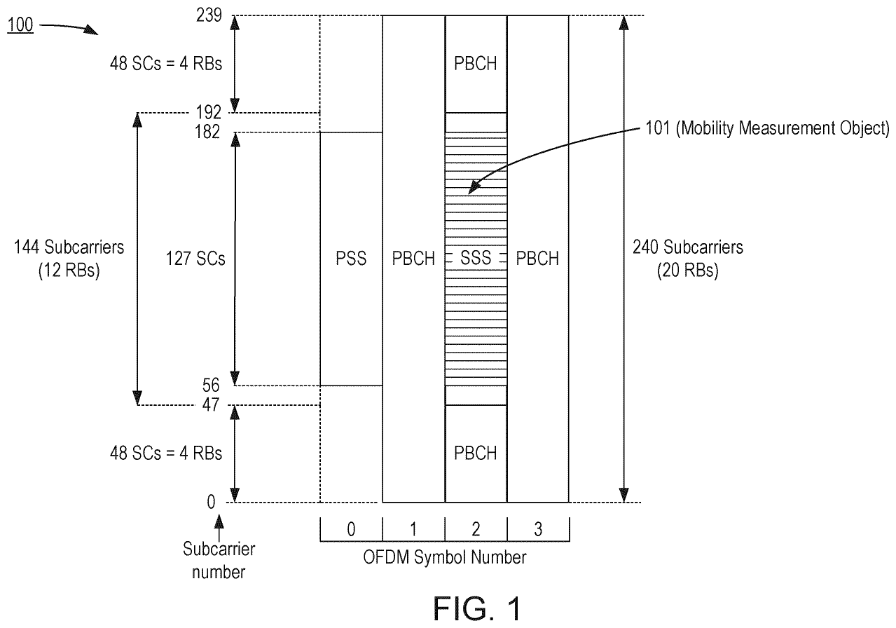

FIG. 2 is a block diagram of a wireless communication device that operates in a wireless communication system in accordance with some inventive embodiments.

FIG. 3 is a block diagram of an exemplary apparatus of a wireless communication device configured to perform mobility measurements in a power efficient way in accordance with some but not necessarily all embodiments consistent with the invention.

FIG. 4 is, in one respect, a flowchart of actions taken by the secondary receiver with respect to performance of mobility measurements in accordance with some but not necessarily all embodiments consistent with the invention.

FIG. 5 is a block diagram of an exemplary controller in accordance with some but not necessarily all exemplary embodiments consistent with the invention.

### DETAILED DESCRIPTION

The various features of the invention will now be described in connection with a number of exemplary embodiments with reference to the figures, in which like parts are identified with the same reference characters.

To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

As mentioned above, the UE energy consumption cost of periodically activating the radio and performing sample collection and baseband processing is high, especially for UEs with low-volume and/or infrequent data transmissions that stay in idle/inactive mode during the majority of their operating time. This energy consumption in turn reduces the UE's battery time.

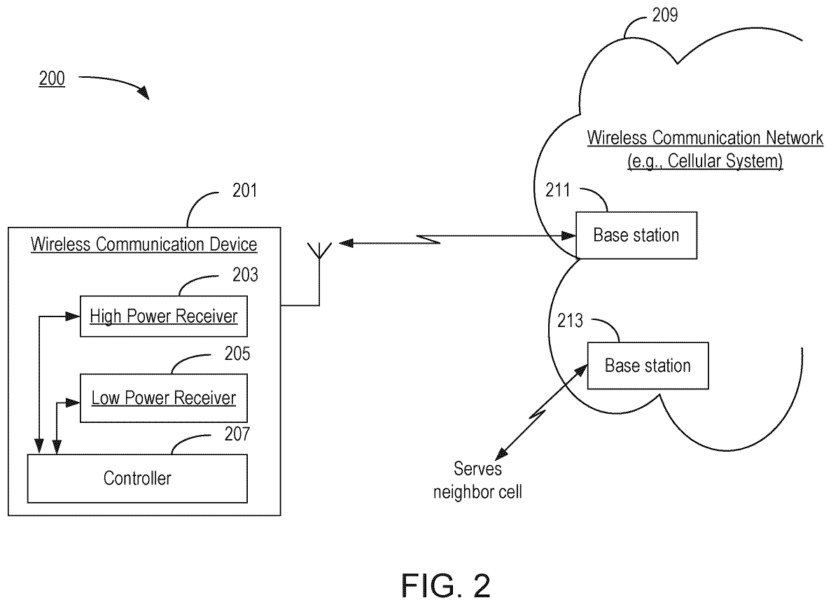

Referring now to FIG. 2, a wireless communication device (e.g., a UE) 201 operates in a wireless communication system that includes a wireless communication network 209. The network 209 includes a network node (e.g., base station) 211 that serves the wireless communication device 201, and other nodes (e.g., base station 213) that serve neighbor or other cells in the system.

To address the above-identified and/or related issues, in one aspect of embodiments consistent with the invention, the technology involves equipping the wireless communication device 201 with both a primary connectivity radio (including a primary receiver 203) and a secondary receiver 205. The primary connectivity radio has full functionality and is therefore capable of performing any radio-related task at a level of performance that a UE might need to perform. Along with this capability are the power consumption problems mentioned earlier.

The secondary receiver 205 is deliberately designed to consume power at a substantially lower rate than the primary receiver 203. This lower power consumption can, for example, be achieved by any number of ways, including without limitation designing the secondary receiver 205 to operate over a narrow bandwidth compared to the primary receiver, using a simplified RF design, constructing the secondary receiver 205 from parts having broader limits of tolerance, and the like. While the secondary receiver 205 is thereby made to operate more power efficiently, a consequence of the steps taken to achieve this is a likelihood that its performance may not be as accurate and/or reliable as that of the primary receiver.

In operation, power savings are achieved by invoking the secondary receiver 205 to perform mobility measurements that rely on time-domain correlation rather than frequency domain processing. The time-correlation may be performed on previously identified measurement objects, such as on the SSS in the SSB. The SSS contents used to create the reference signal(s) for correlation are known from previous measurements or the SI using the main receiver. The primary receiver 203 can determine relevant SSB locations and contents for the UE's serving cell and, in some embodiments, also for known candidate neighbor cells. By using the secondary receiver 205 in this manner, less energy is required to perform the mobility measurements.

Further energy can be achieved by maintaining the primary receiver 203 in a deep (power saving) sleep state, while the secondary receiver 205 is performing the mobility measurements.

Another aspect of some embodiments consistent with the invention involves calibrating the secondary receiver 205 so that its link power/quality estimate can be used as a basis for making decisions about whether to perform a mobility procedure (e.g., by converting the measurement produced by the secondary receiver into an estimate that the primary receiver would have produced).

In another aspect of some embodiments, in order to perform sample collection and measurement processing, the secondary receiver 205 can use the PSS for locating the SSB and also for automatic gain control (AGC). The PSS can also be used for time/frequency synchronization. Alternatively, the secondary receiver 205 may use the SSS reference sequence directly for synchronization.

In another aspect of some embodiments, when the L′E decides that a mobility procedure should be performed, it further decides whether that procedure will be performed in a control unit of the secondary receiver 205, or whether the main (primary) receiver 203 should be activated for this purpose. The decision can be based on, for example, whether the mobility procedure can be based on the secondary receiver's measurement results (in which case the mobility procedure is performed by the secondary receiver 205), or whether the main receiver 203 needs to be activated due to, for example, a need to find additional candidate cells and/or to perform other operations not supported by the secondary receiver 205.

These and other aspects are described further in the following.

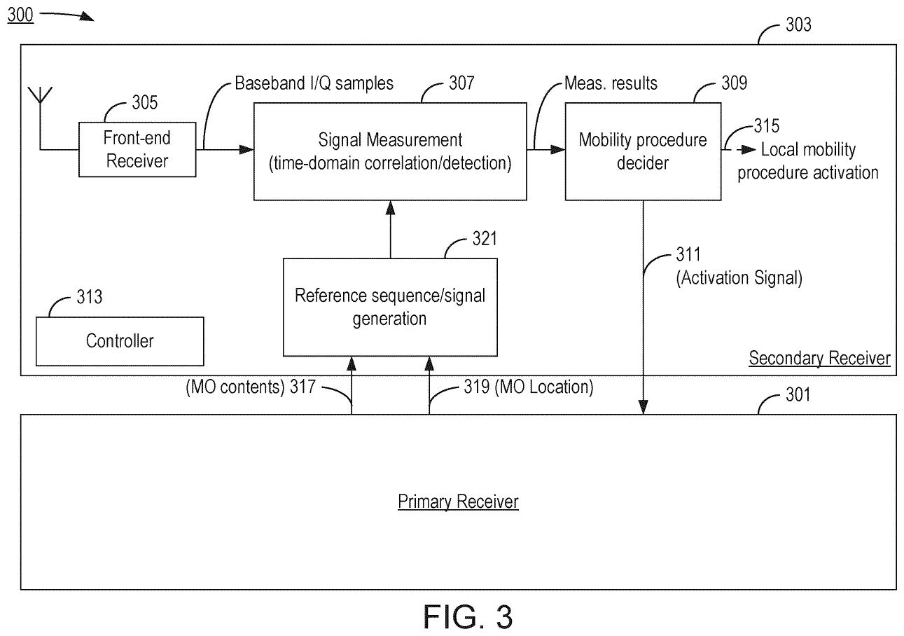

FIG. 3 is a block diagram of an exemplary apparatus 300 of a wireless communication device configured to perform mobility measurements in a power efficient way in accordance with some but not necessarily all embodiments consistent with the invention. As described earlier, the apparatus 300 comprises a primary receiver 301 and a secondary receiver 303. The primary receiver 301 is a receiver of a primary connectivity radio. Such receivers function as “main” receivers in conventional wireless communication equipment and are well known in the art.

An important criterion for the choice of the design of the secondary receiver 303 is that its rate of power consumption (or average power consumption rate, averaged over gating) should be substantially lower than that of the primary receiver 301. Simplified RF design and configuration to operate only over a narrow bandwidth can contribute to its power savings. It is advantageous for the power consumption rate of the secondary receiver 303 to be, for example, only 10-20% of the average deep sleep power consumption rate of the primary receiver 301.

The secondary receiver 303 comprises a receiver front end 305 that, for example, includes an RF filter and low noise amplifier (LNA) that can be implemented/configured to operate on a signal having a predetermined or alternatively configurable carrier frequency and narrow bandwidth. The receiver front end 305 may constitute a homodyne or IF receiver with associated IF filter and IF AMP circuitry. Additionally, the RF FE may include an ADC capable of sampling the required reception bandwidth. The sampled Baseband I/Q data are supplied as input to signal measurement circuitry 307 that measures the mobility measurement object 101. The signal measurement circuitry 307 advantageously performs a time-domain based measurement process to produce its measurement, as is described in greater detail below.

The measurement produced by the signal measurement circuitry 307 is supplied to deciding circuitry 309 that assesses the measurement and decides whether a mobility procedure should be performed. In some embodiments, a decision that a mobility procedure should be performed is communicated back to the primary receiver 301, as illustrated by the activation line 311. When activated, the primary receiver 301 responds by performing the required mobility procedure.

In some but not necessarily all embodiments, a controller 313 of the secondary receiver 303 may itself perform the mobility procedure when such performance is needed and assuming that the secondary receiver is capable of performing the necessary functions. This feature is illustrated by the local activation line 315. If the mobility procedure is required but cannot be performed using the secondary receiver 303, the primary receiver 301 will instead be activated.

The secondary receiver can also include a reference sequence/signal generation circuit 321 that generates a reference sequence that is used by the signal measurement circuitry 307.

Activation of mobility procedures is discussed further below.

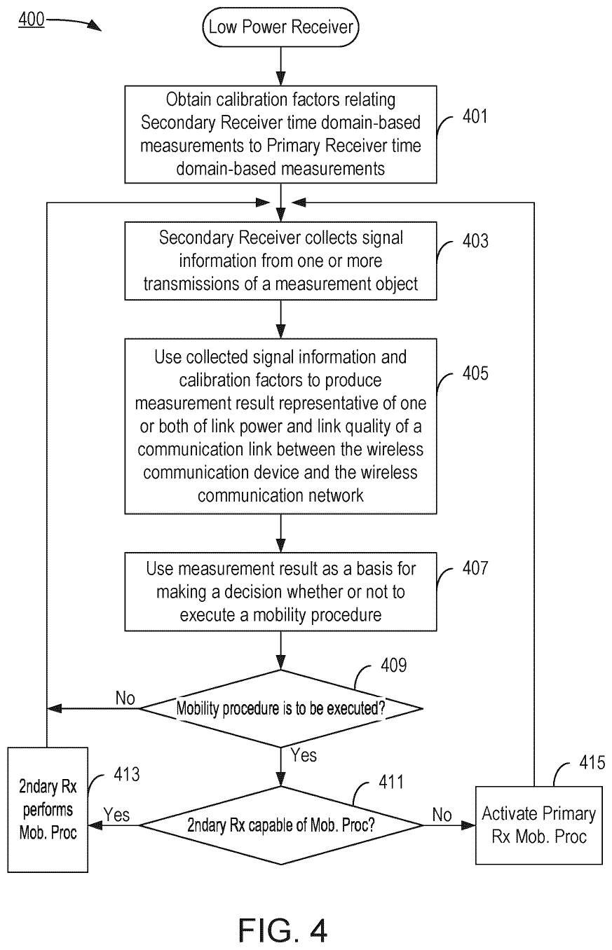

Further aspects of embodiments consistent with the invention are now described with reference to FIG. 4, which in one respect is a flowchart of actions taken by the secondary receiver 303 with respect to performance of mobility measurements. In other respects, the blocks depicted in FIG. 4 can also be considered to represent means 400 (e.g., hardwired or programmable circuitry or other processing means) for carrying out the described actions.

As has been discussed, an objective of the technology described herein is to minimize the energy consumption associated with mobility measurements in a UE. In one aspect, this is achieved by allowing a low-power secondary receiver 303 to perform the mobility measurements instead of the main receiver (e.g., the primary receiver 301). This strategy is especially practical when no new (unknown or previously undetected) mobility measurement objects (equivalently referred to herein simply as “measurement objects”) are to be measured, tracked, or otherwise evaluated. Instead, the secondary receiver 303 is used for measurements of the already known measurement objects. The benefit of using the known measurement objects is that a reference signal describing their contents may be created for low-complexity detection/measurement, and further that their time location is (at least approximately) known, so that the time window over which detection is to occur can be limited. By utilizing this strategy, the primary receiver 301 can be maintained in a deep sleep state.

Looking now at the exemplary embodiment depicted in FIG. 4, the depicted actions pertain to a wireless communication device in a wireless communication network, wherein the wireless communication device comprises a first receiver (e.g., primary receiver 301) that consumes power at a first rate, and a second receiver (e.g., secondary receiver 303) that consumes power at a second rate, wherein the first rate is higher than the second rate.

At step 401, the second receiver obtains one or more calibration factors that relate one or more time domain properties of transmitted signals when received by the first receiver and time domain properties of the transmitted signals when received by the second receiver. Time domain properties include, but are not limited to, signal power, periodicity, energy, and magnitude. This is an important step in order to be able to use the link power/quality estimate provided by the second receiver as a proxy for the first receiver and obtain valid absolute link quality estimates. The calibration may entail determining a scaling factor, or a bias or both to be applied to the second receiver's estimate to obtain the corresponding first receiver estimate.

In some but not necessarily all embodiments, the calibration is performed by causing the first receiver to perform a measurement on a measurement object and also causing the second receiver (either or at a different time) to perform a measurement on the same measurement object. To obtain reliable and usable calibration results, the calibration may be performed with the receivers in the same power states as during the actual mobility measurements (e.g., the first receiver in deep sleep and the second receiver in activated mode). Furthermore, the UE may decide to apply the same type of estimation method in both receivers (e.g., time correlation), or alternatively can have the first receiver use a more accurate estimator for purposes of calibrating the second receiver.

In some but not necessarily all embodiments, the UE may additionally calibrate the noise parameters in the second receiver with respect to those of the first receiver (e.g., if the first and second receivers have RF circuitry that is partly or entirely separate from each other).

In other aspects of some but not necessarily all embodiments, the UE calibrates each beam of the second receiver separately (e.g., if SSB burst is applied), individually calibrates the second receiver for difference cells measurements, and so the like.

At step 403, the second receiver is operated to collect signal information from one or more transmissions of a measurement object that is located within corresponding one or more radiofrequency transmissions performed by the wireless communication network. In some embodiments, this involves using the first receiver of the UE to determine relevant measurement object locations and contents (e.g., detected SSBs or CSI-RS resource configurations provided by the network) and to provide this information to the second receiver. In this way, the second receiver knows exactly how to find the measurement object.

The known measurement objects may be determined for the serving cell and optionally for known candidate neighbor cells. When measurement objects for known candidate neighbor cells are determined, the second receiver may be applied for serving/camping cell quality monitoring and also for monitoring the quality of known neighbor cells. The information about the measurement objects (i.e., MO contents and MO location) can be communicated from the first receiver to the second receiver (e.g., via signal paths 317 for MO contents and 319 for MO location, as illustrated in FIG. 3). A reference sequence/signal generator 321 in the second receiver uses this information to generate necessary reference signals that are supplied to, and used by the signal measurement circuitry 307 for time-domain correlation with the received signal information.

In step 405, the signal information collected by the second receiver and the one or more calibration factors are used to produce a measurement result representative of one or both of signal power and link quality of a communication link between the wireless communication device and the wireless communication network.

In some but not necessarily all embodiments, this measuring entails performing sliding time-domain correlation of the received sample stream with a reference sequence corresponding to the known contents determined by the first receiver or based on the SI and/or 3GPP specifications. The measurement result (e.g., the output of the signal measurement circuit 307) can for example be a link quality estimate, and may be scaled according to the calibration factors.

In an aspect of some but not necessarily all embodiments, a time-domain correlation is performed only in the vicinity of predetermined measurement times (e.g., based on the known DRX configuration and/or SSB locations, and/or beams, and/or cells), and the second receiver is entirely or at least partly powered-off or clock-gated the rest of the time. In some but not necessarily all alternative embodiments, the second receiver is permitted to run continuously (e.g., to maintain a stable temperature and reduce the need to recalibrate).

The second receiver may use the known reference sequence (e.g., the SSS in SSB) for initial AGC, time/frequency synchronization, or a different assisting signal may be used (e.g., the PSS in SSB). To determine and compensate for the actual frequency error, multiple correlation processes may be run, using reference sequences corresponding to suitable frequency-offset copies of the measurement object reference signal or assisting signal. In case correlated measurement objects exist (e.g., closely spaced beams in SSB bursts, or correlated cells, and so on), they can be used to obtain a more accurate synchronization.

In another aspect of some but not necessarily all embodiments, the second receiver collects data on the same measurement object at adjacent multiple occasions. By summing up or averaging the data of the multiple occasions, the signal-to-noise ratio (SNR) can be improved, and measurement accuracy can be improved.

In step 407, the measurement result produced by the second receiver is used as a basis for deciding whether or not to execute a mobility procedure. Apart from the aspect of making a decision based on a measurement from a lower-powered, secondary receiver, this type of decision making follows known methodology and a complete description of it is beyond the scope of this disclosure.

If the decision is that a mobility procedure does not need to be performed (“No” path out of decision block 409), processing reverts back to step 403 and the process is repeated.

If the decision indicates that a mobility procedure needs to be performed (“Yes” path out of decision block 409), then the mobility procedure is performed in the second receiver based on the second receiver's measurement results unless the required mobility procedure is not supported by the second receiver, in which case the main receiver is instead activated for this purpose.

More particularly, if the second receiver is capable of performing the mobility procedure (“Yes” path out of decision block 411), then in step 413 a control unit of the second receiver uses the second receiver's measurement results as estimated cell qualities and may, based on the estimates, determine whether any mobility events are triggered (e.g., the serving cell quality dropping below a threshold or a neighbor cell quality approaching or exceeding the serving cell quality). Furthermore, the UE can use the second receiver's measurements in SSB bursts for beam quality measurements (e.g., if the quality in the current beam is going down and/or if another beam quality becomes better than the current one and the like).

But if any action is required that is not supported by the second receiver (“No” path out of decision block 411), the first receiver is activated and caused to perform the required mobility procedure actions (step 415). Examples of such actions include, without limitation, performing measurements on additional neighbor cells or measurement objects, reporting measurement results to the network, decoding PBCH, initiating handover signaling, and beam recovery). Processing then reverts back to step 403 and the process is repeated.

In some but not necessarily all alternative embodiments, the second receiver is used to determine link quality measurements as discussed above, but only for the purpose of determining whether any mobility events have been triggered. But if measurement reporting is required, then first receiver is activated and caused to perform the measurement.

In some but not necessarily all more conservative alternative embodiments, the second receiver is used only until it is detected that the estimated link quality is within a predetermined distance (e.g., 3 dB) from a quality value that would trigger a mobility event. But the first receiver is thereafter invoked to continue the monitoring if the estimated value becomes even closer to the quality value that triggers the mobility event. In this way, mobility decisions are assured to be based on measurements having the level of accuracy produced by the first receiver.

In other aspects of embodiments consistent with the invention, the various principles discussed above are used in both idle/inactive mode and connected mode mobility measurements. For example, in an idle mode embodiment, the UE uses the secondary receiver if the SSB periodicity is much shorter than the DRX cycle. In a connected mode embodiment, the primary receiver enters a deep sleep at the end of a first onDuration and the secondary receiver is used for measurements instead, as described earlier. However, for one or another predetermined number of SSB measurements prior to the next-occurring onDuration, the primary receiver is again used.

In still further aspects of some but not necessarily all inventive embodiments, the operating power of the secondary receiver 303 is further reduced by including a radio front-end that is designed or otherwise configured for lower sensitivity, less stringent noise figure and/or linearity, and the like such that the secondary receiver 303 is still capable of providing a sufficient signal quality if the link quality to be measured is above a threshold. When obtaining the information about the known measurement object(s), the UE may determine a link quality metric (power, SINR) from the main receiver measurement. In such embodiments, the secondary receiver 303 is activated for performing measurements only if that link condition is satisfied.

In a related embodiment, the radio characteristics of the secondary receiver 303 are configurable, and the configuration is set so as to operate at the lowest possible power consumption rate while still obtaining sufficient measurement quality.

In some embodiments, the secondary receiver 303 may operate using a single antenna. In alternative embodiments, the secondary receiver 303 may use multiple antennas (e.g., the same antennas as are used by the primary receiver 301). In these latter embodiments, the measurement object-related information provided by the primary receiver 301 can additionally include beamforming configuration or combining weight information.

### Extensions

In still further embodiments, the UE performs occasional primary receiver measurements in parallel with secondary receiver measurements in order to monitor their alignment/calibration. If a mismatch or deviation from the LP-receiver operating range is detected, the UE may resume a primary receiver mode of operation for mobility measurements.

In yet other embodiments, the secondary receiver 303 can itself be used as a front end to the primary receiver 301 (e.g., for frequency-domain, PBCH decoding, etc.) or to a reduced-capability configuration of the primary receiver 301.

In still other embodiments, the secondary receiver 303 applied only for operation in a predefined frequency range, SCS, and the like. For example, the secondary receiver 303 may be used for frequency band FR1 but not for FR2, or for subcarrier spacings only lower than 30 kHz but not for higher spacings, or the other way around. Furthermore, the UE may decide to not use the secondary receiver 303 when there is a SSB burst within a specific time, and so on.

In yet other embodiments, if a wakeup signal (WUS) (a non-PDCCH) signal is used for providing paging indications in idle/inactive mode, the secondary receiver 303 may be used for WUS monitoring. This has the advantage of completely eliminating the need for operation of the primary receiver 301 in stable/static situations.

In still other embodiments, the UE uses the secondary receiver 303 to detect PSS sequences and, upon detecting a PSS, the UE performs SSS detection two symbols later even for cells that have not been previously found by the primary receiver 301 (e.g., by correlating with respect to SSS reference sequences that are compatible with the found PSS). The secondary receiver 303 can thus find additional cells even without waking up the primary receiver 301, thus avoiding additional energy expenditures.

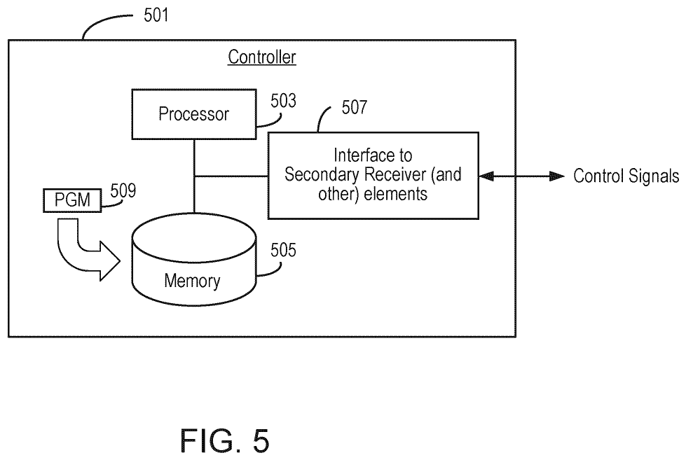

Aspects of an exemplary controller that may be included in the UE (e.g., as the controller 207 or the controller 313) to cause any and/or all of the above-described actions to be performed as discussed in the various embodiments are shown in FIG. 5, which illustrates an exemplary controller 501 in accordance with some but not necessarily all exemplary embodiments consistent with the invention. In particular, the controller 501 includes circuitry configured to carry out any one or any combination of the various functions described above. Such circuitry could, for example, be entirely hard-wired circuitry (e.g., one or more Application Specific Integrated Circuits—“ASICs”). Depicted in the exemplary embodiment of FIG. 5, however, is programmable circuitry, comprising a processor 503 coupled to one or more memory devices 505 (e.g., Random Access Memory, Magnetic Disc Drives, Optical Disk Drives, Read Only Memory, etc.) and to an interface 507 that enables bidirectional communication with other elements of the secondary receiver 303 and, in some embodiments, also the primary receiver 301. A complete list of possible other elements is beyond the scope of this description.

The memory device(s) 505 store program means 509 (e.g., a set of processor instructions) configured to cause the processor 503 to control other system elements so as to carry out any of the aspects described above. The memory device(s) 505 may also store data (not shown) representing various constant and variable parameters as may be needed by the processor 503 and/or as may be generated when carrying out its functions such as those specified by the program means 509.

The above-described embodiments make reference to SSS detection in the SSB to illustrate various aspects that are consistent with inventive embodiments. However, measurement of an SSS is not essential to the invention. The same principle may be used when mobility measurements are performed on other types of signals, such as without limitation, CSI-RS with known contents, or other such reference signals (e.g., TRS, DMRS). Thus, the terms “mobility measurement object” and simply “measurement object” may refer to any such signals.

Further, the various embodiments described above have been exemplified by reference to RRM mobility measurements for cell (L3) mobility. However, the same principles may be used for beam management (L1 mobility) measurements, using SSB or CSI-RS (e.g., for beam detection and beam pair determination).

It is also noted that, when referring to known beams that may be detected and/or measured with the secondary receiver 303, “known” may refer to beams previously detected with the primary receiver 301, or to beams present according to the transmitted SSB info in the SI where the reference sequences are generated based on the SSB index information in the SI and the known SSB format. Note that the SSS contents are the same for all beams in a cell, whereby the SSS from any beam may be detected without beam index information. However, upon detecting an SSS, an associated SSB index may be identified from, for example, the PBCH DMRS sequence.

Embodiments consistent with the invention provide advantages over conventional technology. For example, they allow a UE to save energy associated with mobility measurements, thereby extending battery life because power/energy consumption associated with the secondary receiver can be made several orders of magnitude lower compared to the primary receiver, and significantly lower than or comparable to the deep sleep mode power consumption rate of the primary receiver.

The invention has been described with reference to particular embodiments. However, it will be readily apparent to those skilled in the art that it is possible to embody the invention in specific forms other than those of the embodiment described above. Accordingly, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. A method of operating a wireless communication device in a wireless communication network, wherein the wireless communication device comprises a first receiver that consumes power at a first rate, and a second receiver that consumes power at a second rate, wherein the first rate is higher than the second rate, the method comprising:
obtaining one or more calibration factors that relate time domain properties of transmitted signals when received by the first receiver and time domain properties of the transmitted signals when received by the second receiver;
using the second receiver to collect signal information from one or more transmissions of a measurement object that is located within corresponding one or more radiofrequency transmissions performed by the wireless communication network;
using the signal information collected by the second receiver and the one or more calibration factors to produce a measurement result representative of one or both of signal power and link quality of a communication link between the wireless communication device and the wireless communication network; and
using the measurement result as a basis for deciding whether or not to execute a mobility procedure.

2. The method of claim 1, comprising:
using the first receiver to receive the measurement object; and
determining time domain properties of the measurement object that was received by the first receiver, wherein the time domain properties characterize a timing of transmissions of the measurement object and a time domain representation of a reference sequence represented by the measurement object.

3. The method of claim 2, wherein using the second receiver to collect the signal information from the one or more transmissions of the measurement object comprises:
using the time domain properties of the measurement object as a basis for configuring the second receiver to collect the signal information from the one or more transmissions of the measurement object.

4. The method of claim 1, comprising:
performing the mobility procedure in a controller of the second receiver when it is decided to execute the mobility procedure.

5. The method of claim 1, comprising:
performing the mobility procedure in a controller of the first receiver when it is decided to execute the mobility procedure.

6. The method of claim 1, comprising:
when it is decided to execute the mobility procedure, performing:
deciding whether the second receiver is capable of performing the mobility procedure;
performing the mobility procedure in a controller of the second receiver when it is decided that the second receiver is capable of performing the mobility procedure; and
performing the mobility procedure in a controller of the first receiver when it is decided that the second receiver is not capable of performing the mobility procedure.

7. The method of claim 1, wherein using the signal information collected by the second receiver and the one or more calibration factors to produce the measurement result representative of one or both of signal power and link quality of the communication link between the wireless communication device and the wireless communication network comprises:
producing, from the signal information collected by the second receiver, a first measurement result representative of one or both of signal power and link quality of the communication link between the wireless communication device and the wireless communication network; and
using the calibration factors as a basis for adjusting the first measurement result to form a corrected estimate of a measurement result representative of one or both of signal power and link quality of the communication link between the wireless communication device and the wireless communication network.

8. The method of claim 2,
wherein using the second receiver to collect the signal information from the one or more transmissions of the measurement object comprises:
using the time domain properties of the measurement object as a basis for configuring the second receiver to collect the signal information from the one or more transmissions of the measurement object; and
wherein using the signal information collected by the second receiver and the one or more calibration factors to produce the measurement result representative of one or both of signal power and link quality of the communication link between the wireless communication device and the wireless communication network comprises:
performing sliding time-domain correlation of a sample stream received by the second receiver with the time domain representation of the reference sequence represented by the measurement object.

9. The method of claim 8, wherein forming the estimate of the first radio measurement result representative of the link quality of the communication link between the wireless communication device and the wireless communication network comprises:
scaling a correlation output of the sliding time-domain correlation by one or more of the one or more calibration factors.

10. The method of claim 1, comprising:
when the wireless communication device is operating in a connected mode that comprises alternating awake and sleep states, performing a plurality of measurements of measurement objects during each sleep state by:
using the second receiver to measure a first number of measurement objects that are transmitted during a first-occurring part of the sleep state; and
using the first receiver to measure a second number of measurement objects that are transmitted during a last-occurring part of the sleep state.

11. The method of claim 10, comprising:
switching off the second receiver during each awake state.

12. The method of claim 1, wherein the mobility procedure is one of:
a cell mobility procedure; and
a beam management procedure.

13. The method of claim 1, comprising:
after obtaining the one or more calibration factors, performing:
using the first receiver and the second receiver to measure a same measurement object as one another to obtain a first measurement result and a second measurement result, respectively;
comparing the first measurement result with the second measurement result to produce a comparison result; and
using the first receiver instead of the second receiver to perform further measurements of further occurring measurement objects when the comparison result does not satisfy a predefined criterion.

14. The method of claim 1, comprising:
using the second receiver to monitor received signals to detect a receipt of a wakeup signal; and
causing the first receiver to wake up when the receipt of the wakeup signal is detected.

15. The method of claim 1, comprising:
using the second receiver to perform a cell search procedure.

16. The method of claim 1, wherein obtaining the calibration factors comprises:
using the first receiver to obtain a first calibration measurement by measuring the measurement object of at least one of the one or more transmissions of the measurement object;
using the second receiver to obtain a second calibration measurement by measuring the measurement object of the at least one of the one or more transmissions of the measurement object; and
deriving the calibration factors from a comparison of the first calibration measurement and the second calibration measurement.

17. The method of claim 1, wherein the signal information collected by the second receiver comprises a sample stream, and wherein using the signal information collected by the second receiver and the one or more calibration factors to produce the measurement result representative of one or both of signal power and link quality of the communication link between the wireless communication device and the wireless communication network comprises:
performing sliding time-domain correlation of the sample stream with one or more reference sequences corresponding to known contents of the measurement object.

18. The method of claim 17, wherein using the second receiver to collect signal information from the one or more transmissions of the measurement object is performed only during predetermined measurement times, and wherein the method comprises:
performing the sliding time-domain correlation of the sample stream with the one or more reference sequences corresponding to known contents of the measurement object only at times associated with the predetermined measurement times.

19. The method of claim 1, wherein the measurement object is one or more of:
a Secondary Synchronization Signal (SSS) in a Synchronization Signal Block SSB (SSB);
a Channel State Indicator Reference Signal (CSI-RS); and
a predefined reference signal.

20. A non-transitory computer readable storage medium having stored therein a computer program comprising instructions that, when executed by at least one processor, causes the at least one processor to carry out a method of operating a wireless communication device in a wireless communication network, wherein the wireless communication device comprises a first receiver that consumes power at a first rate, and a second receiver that consumes power at a second rate, wherein the first rate is higher than the second rate, the method comprising:
obtaining one or more calibration factors that relate time domain properties of transmitted signals when received by the first receiver and time domain properties of the transmitted signals when received by the second receiver;
using the second receiver to collect signal information from one or more transmissions of a measurement object that is located within corresponding one or more radiofrequency transmissions performed by the wireless communication network;
using the signal information collected by the second receiver and the one or more calibration factors to produce a measurement result representative of one or both of signal power and link quality of a communication link between the wireless communication device and the wireless communication network; and
using the measurement result as a basis for deciding whether or not to execute a mobility procedure.

21. (canceled)

22. An apparatus for operating a wireless communication device in a wireless communication network, wherein the wireless communication device comprises a first receiver that consumes power at a first rate, and a second receiver that consumes power at a second rate, wherein the first rate is higher than the second rate, the apparatus comprising:
circuitry configured to obtain one or more calibration factors that relate time domain properties of transmitted signals when received by the first receiver and time domain properties of the transmitted signals when received by the second receiver;
circuitry configured to use the second receiver to collect signal information from one or more transmissions of a measurement object that is located within corresponding one or more radiofrequency transmissions performed by the wireless communication network;
circuitry configured to use the signal information collected by the second receiver and the one or more calibration factors to produce a measurement result representative of one or both of signal power and link quality of a communication link between the wireless communication device and the wireless communication network; and
circuitry configured to use the measurement result as a basis for deciding whether or not to execute a mobility procedure.

23. The apparatus of claim 22, comprising:
circuitry configured to use the first receiver to receive the measurement object; and
circuitry configured to determine time domain properties of the measurement object that was received by the first receiver, wherein the time domain properties characterize a timing of transmissions of the measurement object and a time domain representation of a reference sequence represented by the measurement object.

24. The apparatus of claim 23, wherein the circuitry configured to use the second receiver to collect the signal information from the one or more transmissions of the measurement object comprises:
circuitry configured to use the time domain properties of the measurement object as a basis for configuring the second receiver to collect the signal information from the one or more transmissions of the measurement object.

25. The apparatus of claim 22, comprising:
circuitry configured to perform the mobility procedure in a controller of the second receiver when it is decided to execute the mobility procedure.

26. The apparatus of claim 22, comprising:
circuitry configured to perform the mobility procedure in a controller of the first receiver when it is decided to execute the mobility procedure.

27. The apparatus of claim 22, comprising:
circuitry configured to, when it is decided to execute the mobility procedure, perform:
deciding whether the second receiver is capable of performing the mobility procedure;
performing the mobility procedure in a controller of the second receiver when it is decided that the second receiver is capable of performing the mobility procedure; and
performing the mobility procedure in a controller of the first receiver when it is decided that the second receiver is not capable of performing the mobility procedure.

28. The apparatus of claim 22, wherein the circuitry configured to use the signal information collected by the second receiver and the one or more calibration factors to produce the measurement result representative of one or both of signal power and link quality of the communication link between the wireless communication device and the wireless communication network comprises:
circuitry configured to produce, from the signal information collected by the second receiver, a first measurement result representative of one or both of signal power and link quality of the communication link between the wireless communication device and the wireless communication network; and
circuitry configured to use the calibration factors as a basis for adjusting the first measurement result to form a corrected estimate of a measurement result representative of one or both of signal power and link quality of the communication link between the wireless communication device and the wireless communication network.

29. The apparatus of claim 23,
wherein the circuitry configured to use the second receiver to collect the signal information from the one or more transmissions of the measurement object comprises:
circuitry configured to use the time domain properties of the measurement object as a basis for configuring the second receiver to collect the signal information from the one or more transmissions of the measurement object; and
wherein the circuitry configured to use the signal information collected by the second receiver and the one or more calibration factors to produce the measurement result representative of one or both of signal power and link quality of the communication link between the wireless communication device and the wireless communication network comprises:
circuitry configured to perform sliding time-domain correlation of a sample stream received by the second receiver with the time domain representation of the reference sequence represented by the measurement object.

30. The apparatus of claim 29, comprising circuitry configured to form the estimate of the first radio measurement result representative of the link quality of the communication link between the wireless communication device and the wireless communication network by performing:
scaling a correlation output of the sliding time-domain correlation by one or more of the one or more calibration factors.

31. The apparatus of claim 22, comprising:
circuitry configured to, when the wireless communication device is operating in a connected mode that comprises alternating awake and sleep states, perform a plurality of measurements of measurement objects during each sleep state by:
using the second receiver to measure a first number of measurement objects that are transmitted during a first-occurring part of the sleep state; and
using the first receiver to measure a second number of measurement objects that are transmitted during a last-occurring part of the sleep state.

32. The apparatus of claim 31, comprising:
circuitry configured to switch off the second receiver during each awake state.

33. The apparatus of claim 22, wherein the mobility procedure is one of:
a cell mobility procedure; and
a beam management procedure.

34. The apparatus of claim 22, comprising:
circuitry configured to, after obtaining the one or more calibration factors, perform:
using the first receiver and the second receiver to measure a same measurement object as one another to obtain a first measurement result and a second measurement result, respectively;
comparing the first measurement result with the second measurement result to produce a comparison result; and
using the first receiver instead of the second receiver to perform further measurements of further occurring measurement objects when the comparison result does not satisfy a predefined criterion.

35. The apparatus of claim 22, comprising:
circuitry configured to use the second receiver to monitor received signals to detect a receipt of a wakeup signal; and
circuitry configured to cause the first receiver to wake up when the receipt of the wakeup signal is detected.

36. The apparatus of claim 22, comprising:
circuitry configured to use the second receiver to perform a cell search procedure.

37. The apparatus of claim 22, wherein the circuitry configured to obtain the calibration factors comprises:
circuitry configured to use the first receiver to obtain a first calibration measurement by measuring the measurement object of at least one of the one or more transmissions of the measurement object;
circuitry configured to use the second receiver to obtain a second calibration measurement by measuring the measurement object of the at least one of the one or more transmissions of the measurement object; and
circuitry configured to derive the calibration factors from a comparison of the first calibration measurement and the second calibration measurement.

38. The apparatus of claim 22, wherein the signal information collected by the second receiver comprises a sample stream, and wherein the circuitry configured to use the signal information collected by the second receiver and the one or more calibration factors to produce the measurement result representative of one or both of signal power and link quality of the communication link between the wireless communication device and the wireless communication network comprises:
circuitry configured to perform sliding time-domain correlation of the sample stream with one or more reference sequences corresponding to known contents of the measurement object.

39. The apparatus of claim 38, wherein the circuitry configured to use the second receiver to collect signal information from the one or more transmissions of the measurement object is activated only during predetermined measurement times, and wherein the apparatus comprises:
circuitry configured to perform the sliding time-domain correlation of the sample stream with the one or more reference sequences corresponding to known contents of the measurement object only at times associated with the predetermined measurement times.

40. The apparatus of claim 22, wherein the measurement object is one or more of:
a Secondary Synchronization Signal, SSS, in a Synchronization Signal Block (SSB);
a Channel State Indicator Reference Signal (CSI-RS); and
a predefined reference signal.
